(19) United States
(12) Patent Application Publication
(10) Pub. No.: US 2017/0257518 A1
(43) Pub. Date: Sep. 7, 2017

(54) DATA PROCESSING APPARATUS, METHOD FOR CONTROLLING DATA PROCESSING APPARATUS, AND STORAGE MEDIUM

(71) Applicant: CANON KABUSHIKI KAISHA, Tokyo (JP)

(72) Inventor: Daisuke Matsunaga, Tokyo (JP)

(21) Appl. No.: 15/443,915

(22) Filed: Feb. 27, 2017

(30) Foreign Application Priority Data
Mar. 1, 2016 (JP) 2016-038733

(51) Int. Cl. H04N 1/32; G06F 5/06; G06F 13/38; G06F 13/42

(52) U.S. Cl. CPC H04N 1/32491; G06F 13/4282; G06F 5/065; G06F 13/385; G06F 2205/067; H04N 2201/0094

(57) ABSTRACT

A data processing apparatus includes a first memory control unit and a second memory control unit. The first memory control unit performs data transfer via an interface of a first bus form. The second memory control unit performs data transfer between a memory device connected via an interface of a second bus form. The first memory control unit and the second memory control unit are connected by a local bus. The memory control unit is provided in the local bus to control, via a predetermined buffer, a write access or a read access to the first memory control unit from the second memory control unit and control, via the predetermined buffer, a read access or a write access to the second memory control unit from the first memory control unit.

### BACKGROUND OF THE INVENTION

Field of the Invention

The present disclosure relates to a data processing apparatus, a method for controlling data processing apparatus, and a storage medium.

Description of the Related Art

In a recent image processing apparatus, such as a multi-function printer (MFP), a plurality of processes (a copy job, a print job, a send job, etc.) can be selected in response to a request from the user. Image processing in accordance with each process is performed by hardware or software.

A configuration in which a controller, as a control unit of the MFP, includes a central processing unit (CPU) and an image processing application-specific integrated circuit (ASIC), and an image processing accelerator configured by hardware built is the image processing ASIC and the CPU operate in cooperation to share image processing is proposed.

In the image processing ASIC, both the CPU and the image processing ASIC may have work memory, such as double data rate (DDR), and the image processing ASIC may have a general-purpose Peripheral Component Interconnect (PCI) Express (PCIe) interface (I/F) for connecting the CPU and the ASIC. The image processing ASIC may have a general-purpose Serial AT Attachment (SATA) I/F to connect the image processing ASIC and a hard disk drive (HDD) which stores image data.

Some systems provided with such a plurality of I/Fs may have a direct memory access controller (DMAC) in order to reduce processing load of software related to data transfer between I/Fs (Japanese Patent Laid-Open No. 2012-160997).

In the image processing ASIC, the DMAC performs data transfer between an address space of the HDD represented by a sector and a local bus address space inside the image processing ASIC. As described in Japanese Patent Laid-Open No. 2014-219941, if a part of the local bus address space is assigned as an address window of the PCIe I/F, the DMAC can directly access memory of a device to be connected to the PCIe I/F.

Therefore, the DMAC can perform data transfer between the HDD connected to the SATA I/F and the memory of the device connected to the PCIe I/F not via unnecessary software control.

However, the method for assigning a part of the local bus address space of the image processing ASIC as a PCIe I/F address window as described above has some issues.

First, if the size of the local bus address space is limited to a predetermined size (for example, 32-bit space: 4 gigabyte (GB)), the part of the local bus address space needs to be assigned to anywhere other than the PCIe address space. Therefore, there is a possibility that a sufficient area cannot be assigned to the PCIe address space.

Similarly, if a device connected to the PCIe I/F has memory of large capacity and the address space thereof is larger than the local bus address space of the image processing ASIC, there is a possibility that a sufficient area cannot be assigned to the PCIe address space.

Therefore, data transfer to an arbitrary memory area of a device connected to the PCIe I/F cannot be performed in a single data transfer event by the DMAC. Therefore, data needs to be reput in another memory area by, for example, memory copy by a CPU, etc. in the device connected to the PCIe I/F, whereby data transfer performance becomes lower. Here, a sufficient area can be assigned if the local bus address space inside the image processing ASIC is extended, but since it is necessary to increase a bus width of the local bus, there is an issue that a circuit structure is increased.

### SUMMARY OF THE INVENTION

According to an aspect of the present invention, a data processing apparatus includes a first memory control unit configured to perform data transfer via an interface of a first bus form, and a second memory control unit configured to perform data transfer between a memory device connected via an interface of a second bus form, wherein the first memory control unit and the second memory control unit are connected by a local bus, and a memory control unit is provided in the local bus to control, via a predetermined buffer, a write access or a read access to the first memory control unit from the second memory control unit and control, via the predetermined buffer, a read access or a write access to the second memory control unit from the first memory control unit.

Further features of the present invention will become apparent from the following description of embodiments with reference to the attached drawings.

### BRIEF DESCRIPTION OF THE DRAWINGS

FIG. 1 is a block diagram illustrating a configuration of an information processing apparatus.

FIGS. 2A and 2B illustrate address spaces for performing an address translation process.

FIG. 3 illustrates address spaces for performing an address translation process.

FIG. 4 illustrates address spaces for performing an address translation process.

FIG. 5 is a block diagram illustrating a configuration of a FIFO control unit.

FIG. 6 is a flowchart illustrating a method for controlling a data transfer device.

FIG. 7 illustrates descriptor tables.

FIG. 8 illustrates descriptor tables.

FIG. 9 is a block diagram illustrating a configuration of an information processing apparatus.

FIG. 10 is a detailed block diagram of a configuration of an intervene unit.

FIG. 11 is a flowchart illustrating a method for controlling a data transfer device.

### DESCRIPTION OF THE EMBODIMENTS

Hereinafter, carrying out the embodiments will be described with reference to the drawings.

### System Configuration

### First Embodiment

### Configuration of Image Processing Apparatus

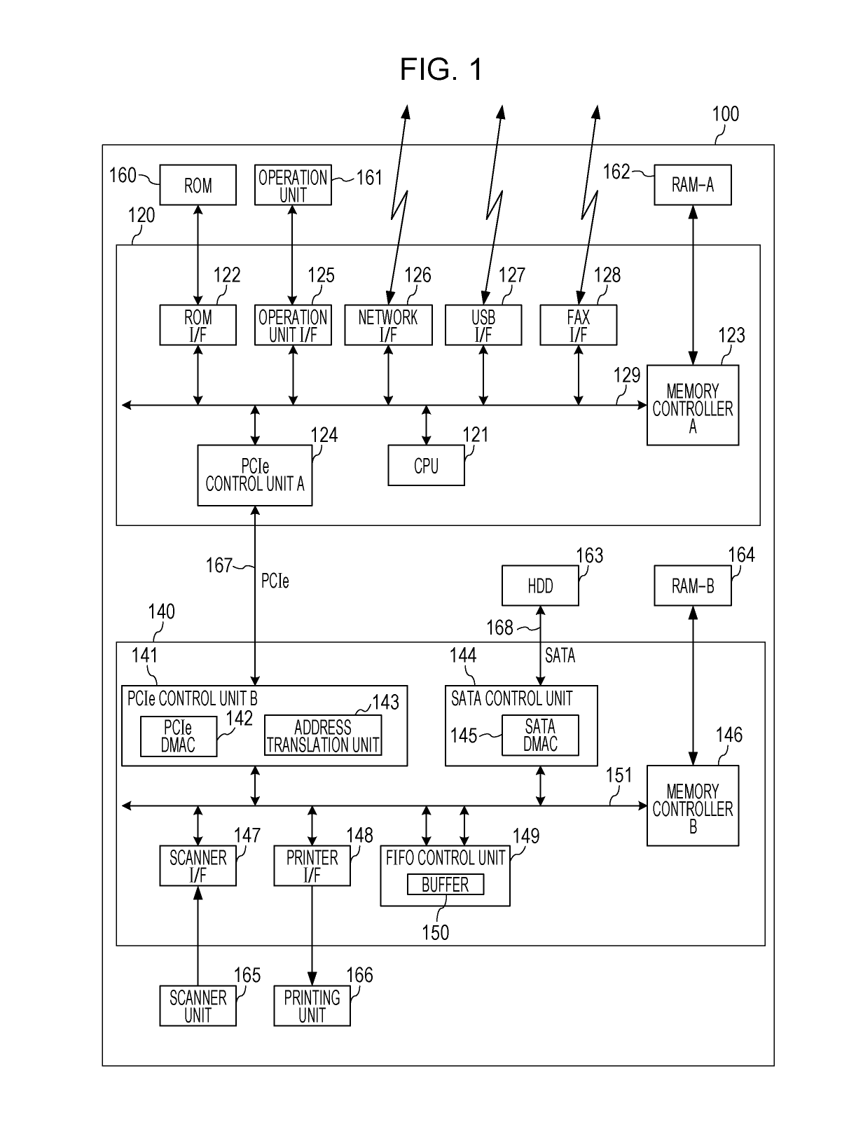

FIG. 1 is a block diagram illustrating a configuration of an information processing apparatus according to the present embodiment. Illustrated is a configuration of an image processing apparatus 100 which is an information processing apparatus provided with a mechanism for increasing transfer efficiency by a cooperative operation of a Serial AT Attachment Direct Memory Access (SATA DMA) and a Peripheral Component Interconnect (PCI) Express Direct Memory Access (PCIe DMA). In the present embodiment, the configuration will be described with reference to an image processing apparatus which is an information processing apparatus which performs image processing as an example. The image processing apparatus includes a first memory control unit which performs data transfer via an interface of a first bus form (a PCIe root complex (hereinafter, RC)). The image processing apparatus further includes a second memory control unit which performs data transfer between a memory device connected via an interface of a second bus form (a PCIe end point (hereinafter, EP)). Here, the first bus form is a PCI bus and the second bus form is a SATA bus, for example. The interface of the first bus form is a PCIe interface and the interface of the second bus form is a SATA interface, for example.

In FIG. 1, a main controller unit of the image processing apparatus 100 is constituted mainly by a PCIe root complex (hereinafter, RC) 120 and a PCIe end point (hereinafter, EP) 140, which are mutually connected by a PCIe 167 to communicate with each other. The PCIe RC 120 is configured as follows.

A CPU 121 accesses programs and data in ROM 160 and RAM-A 162 via a ROM I/F 122 and a memory controller A 123, and controls the entire image processing apparatus 100. A PCIe control unit A 124 is connected with the PCIe EP 140 via the PCIe 167 and performs high-speed data communication. An operation unit 161 is connected with an operation unit I/F 125. A user can provide a job input instruction, etc. to the image processing apparatus 100 via the operation unit 161.

A network I/F 126 is used for data communication with an external apparatus for the input of a print job from a PC, for example. A storage device, such as USB memory, is connected with a USB I/F 127 which is used for printing image data in the storage device, etc. A FAX I/F 128 is used, for example, to receive and print data from a facsimile line. These modules are connected with one another by a local bus 129, such as an AXI and an AHB.

The PCIe EP 140 is configured as follows.

A PCIe control unit B 141 is connected with the PCIe RC 120 via the PCIe 167 and performs high-speed data communication. In particular, the PCIe control unit B 141 includes a PCIe DMAC 142 and an address translation unit 143. These will be described in more detail later.

A SATA control unit 144 is connected with a HDD 163 via a SATA 168 and controls reading and writing of data to the HDD 163. The SATA control unit 144 includes a SATA DMAC 145, and can efficiently perform reading and writing of data to the HDD 163 without performing fine software control by the CPU 121. This will also be described in more detail later.

RAM-B 164 is connected with a memory controller B 146. The RAM-B 164 used to store image data read by, for example, a scanner unit 165 which is an image processing device via a scanner I/F 147. The image data stored in the RAM-B 164 is output via a printer I/F 148 to perform output by a printing unit 166 which is an image processing device, or stored in the HDD 163 via the SATA control unit 144. Further, the image data stored in the RAM-B 164 is transferred to the PCIe RC 120 via the PCIe 167. The image data may be transferred to an external PC via the network I/F 126, may be stored in the USB memory via the USB I/F 127, or transmitted by a facsimile via the FAX I/F 128.

A FIFO control unit 149 of a first-in first-out (FIFO) form may perform FIFO control of a buffer 150 provided therein to cooperatively operate the PCIe DMAC 142 and the SATA DMAC 145. This will also be described in more detail later. These modules are connected with one another by a local bus 151, such as an AXI and an AHB.

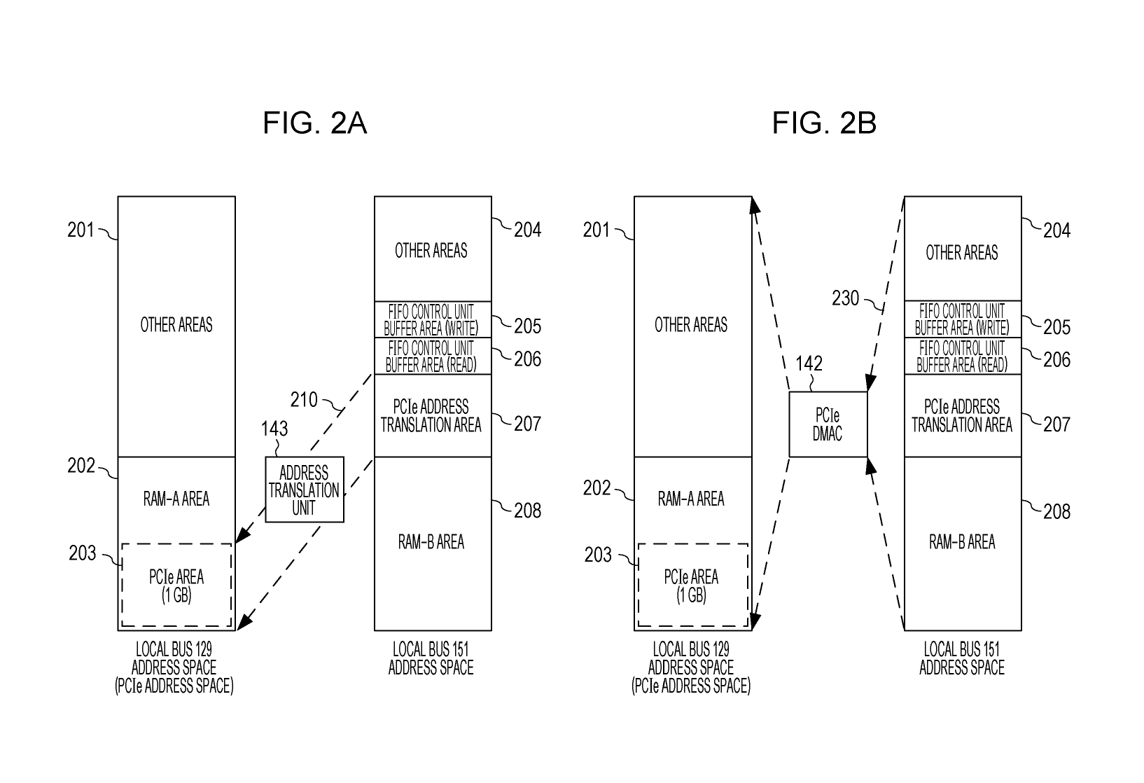

FIGS. 2A and 2B illustrate address spaces describing an address translation process of the local bus in the information processing apparatus illustrated in FIG. 1. In this example, address translation during data transfer performed by the PCIe control unit B 141 between an address space of the local bus 129 on the side of the PCIe RC 120 (a PCIe address space) and an address space of the local bus 151 on the side of the PCIe EP 140 will be described.

FIG. 2A illustrates a method of address translation by the address translation unit 143 and FIG. 2B illustrates a method of address translation by the PCIe DMAC 142. Hereinafter, a process in which the address translation unit 143 translates predetermined address information into an address space managed by a device connected with an interface of a first bus form will be described. The device here is the PCIe RC 120, for example.

In FIG. 2A, the address space of the local bus 151 includes a PCIe address translation area 207 for performing address translation by the address translation unit 143. When a master on the side of the local bus 151 accesses the PCIe address translation area 207, the address translation unit 143 performs translation into an address on the side of the local bus 129 (a PCIe address).

Then the address translation unit 143 accesses a PCIe area 203 mapped on the local bus 129 side via the PCIe 167 (translation 210). In this manner, only an area of a size mappable in an address space on the side of the local bus can be disposed.

Therefore, if the local bus 151 side has a 32-bit address space, for example, an area of 4 GB of space at the maximum can be used as the PCIe address translation area 207. However, address mapping of the local bus 151 requires a RAM-B area 208 and other areas, such as an area of a setting register of an unillustrated image processing module provided in the image processing apparatus 100 (other areas 204).

Therefore, the volume of the PCIe address translation area 207 is defined to 1 GB in the present embodiment. If the address space on the side of the local bus 151 is extended to a 64-bit address space, an area mappable as the PCIe address translation area 207 can be increased, as a trade-off with a cost hike due to an increase in a circuit structure.

Next, in FIG. 2B, the PCIe DMAC 142 may designate the address space of the local bus 151 and the PCIe address space as an address of a transfer source and an address of a transfer destination.

Therefore, data transfer can be performed between arbitrary spaces in the entire area of these two address spaces (translation 230). The PCIe DMAC 142 an the present embodiment may perform a discrete process using a descriptor table, whereby more efficient continuous data transmission can be performed with reduced software control.

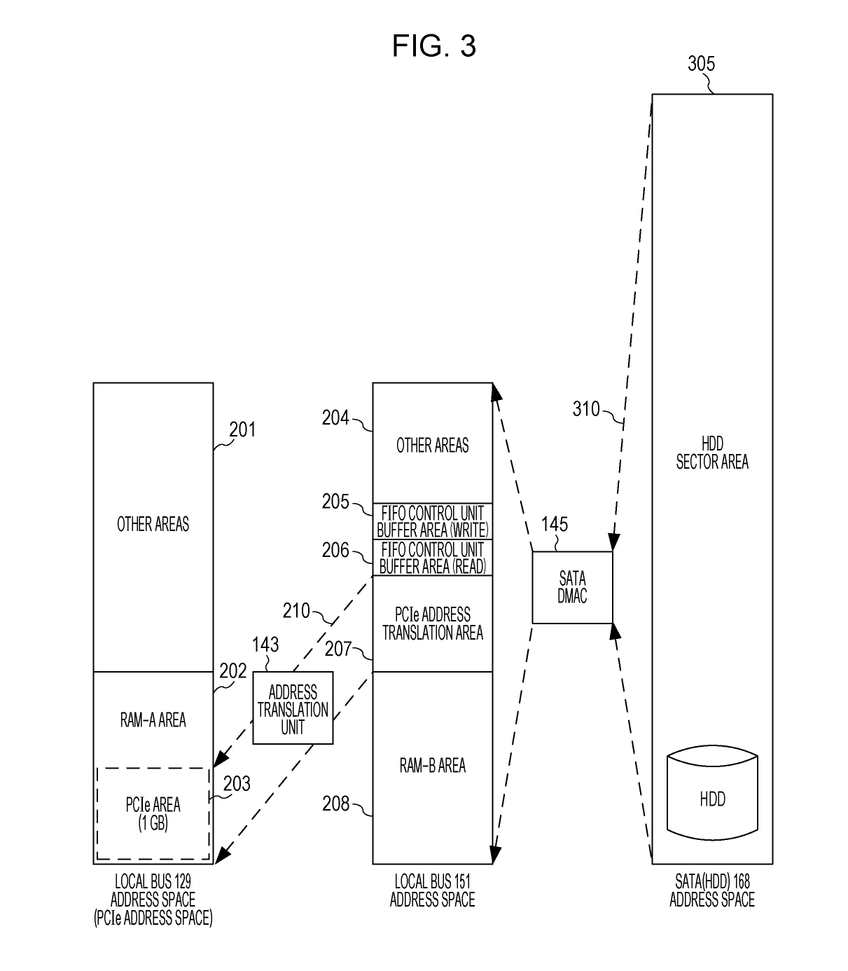

FIG. 3 illustrates address spaces for performing an address translation process in the information processing apparatus illustrated in FIG. 1. In this example, how the SATA control unit 144 performs address translation between the SATA address space on the side of the HDD 163 (a HDD sector area 305) and the address space of the local bus 151 on the side of the PCIe EP 140 during data transfer will be described.

In FIG. 3, the SATA DMAC 145 may designate the SATA address space and the address space of the local bus 151 as an address of a transfer source and an address of a transfer destination. Therefore, data transfer can be performed between arbitrary spaces in the entire area of these two address spaces (translation 310).

The PCIe address translation area 207 described above is included in an area which can be set as the address space of the local bus 151. Therefore, direct data transfer to the RAM-A 162 on the side of the PCIe RC from the HDD 163 can be performed only in a limited area.

The SATA DMAC 145 in the present embodiment may perform a discrete process using a descriptor table, whereby more efficient continuous data transmission can be performed with reduced software control.

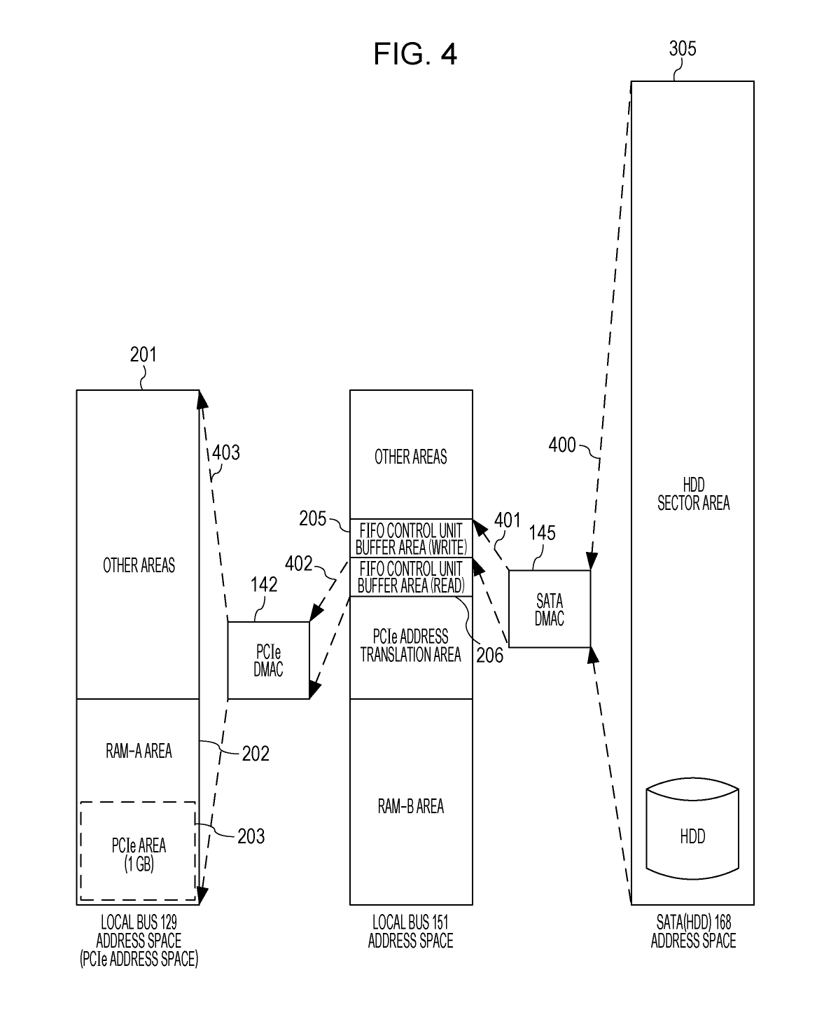

FIG. 4 illustrates address spaces for performing an address translation process in the information processing apparatus illustrated in FIG. 1.

In this example, a method of address translation by cooperatively operating the PCIe DMAC 142 and the SATA DMAC 145 via intervention of the FIFO control unit 149 during data transfer will be described. Although a case where data transfer is performed to the RAM-A 162 of the PCIe RC 120 from the HDD 163 will be described for the ease of description, the same process can be performed in the opposite direction. First, the SATA DMAC 145 designates a predetermined address of the HDD sector area 305 as a transfer source, and designates a buffer area 205 for performing a write access to the buffer 150 of the FIFO control unit 149 as a transfer destination.

Next, the PCIe DMAC 142 designates a buffer area 206 for performing a read access to the buffer 150 of the FIFO control unit 149 as a transfer source. The PCIe DMAC 142 designates arbitrary address in the address space of the local bus 129 (usually, a RAM-area A 202) as a transfer destination. Operation start of the PCIe DMAC 142 and the SATA DMAC 145 is respectively instructed by software running on the CPU 121 after address setting. Then, the PCIe DMAC 142 and the SATA DMAC 145 operate to perform data write and data read to the buffer 150 in parallel while being intervened by the FIFO control unit 149.

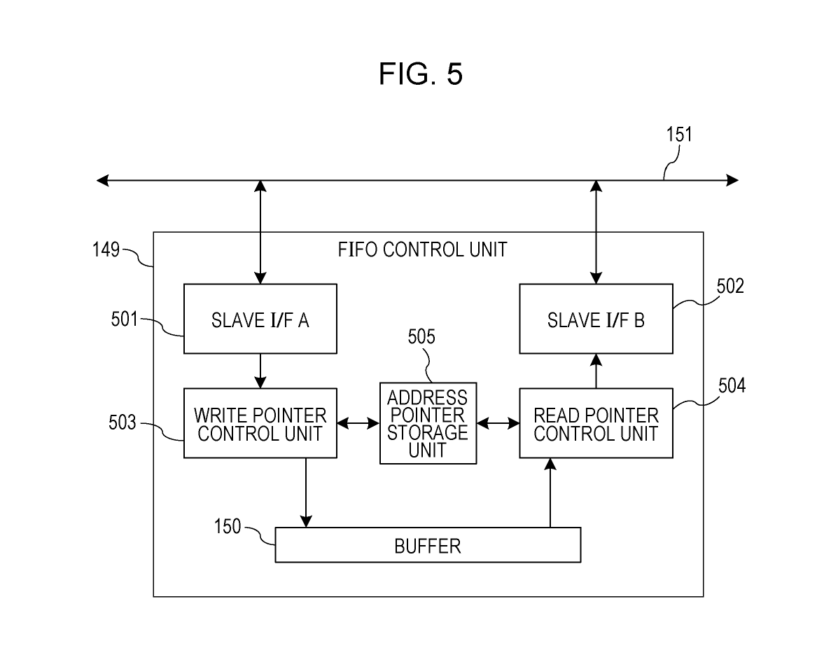

FIG. 5 is a block diagram illustrating a configuration of the FIFO control unit 149 illustrated in FIG. 1. In this example, a configuration of the FIFO control unit 149 which implements the parallel operations will be described.

In FIG. 5, the FIFO control unit 149 includes two I/Fs, i.e., a slave I/F A 501 and a slave I/F B 502, as the I/Fs with the local bus 151. The slave I/F A 501 recognizes an access to the address of the buffer area (write) 205 of the FIFO control unit 149 from the master, such as the PCIe DMAC 142 and the SATA DMAC 145, as an access to the slave I/F A 501.

The slave I/F B 502 recognizes an access to the address of the buffer area (read) 206 of the FIFO control unit 149 from the master, such as the PCIe DMAC 142 and the SATA MAC 145, as an access to the slave I/F B 502. A write pointer control unit 503 checks validity of the address and available capacity of the buffer 150 with respect to the write access transferred from the slave I/F A 501, and performs data write to the buffer 150.

A read pointer control unit 504 checks validity of the address and whether the read data is sufficiently stacked in the buffer 150 with respect to the read access transferred from the slave I/F A 502, and performs data read from the buffer 150. An address pointer storage unit 505 has write pointer information and read pointer information which are updated from the write pointer control unit 503 and the read pointer control unit 504. From the pointer information, the address pointer storage unit 505 calculates information about a data volume stored in the buffer 150 and an available data volume, and transmits the calculated data volume to each of the pointer control units 503 and 504.

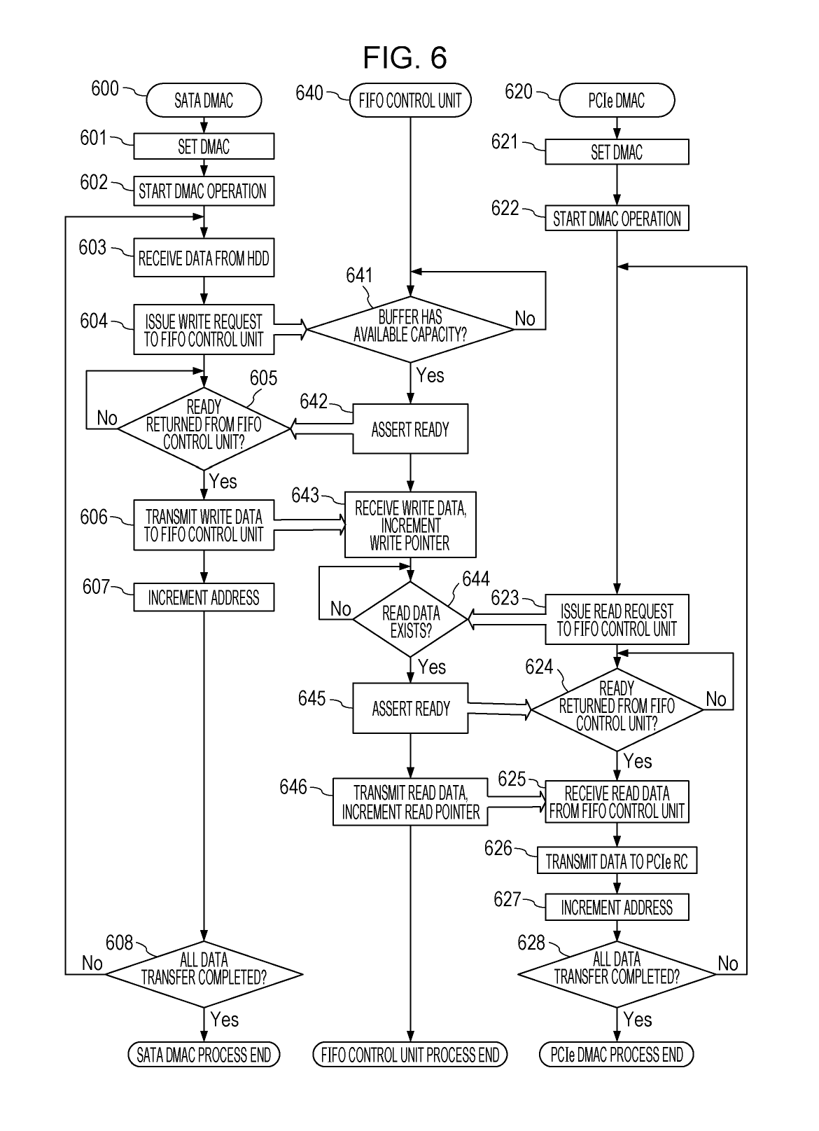

FIG. 6 is a flowchart illustrating a method for controlling a data transfer device according to the present embodiment. Hereinafter, cooperative processing of the FIFO control unit 149, the PCIe DMAC 142, and the SATA DMAC 145 will be described. A process flowchart 600 illustrates an operation of the SATA DMAC 145. A process flowchart 640 illustrates an operation of the FIFO control unit 149. A process flowchart 620 illustrates an operation of the PCIe DMAC 142.

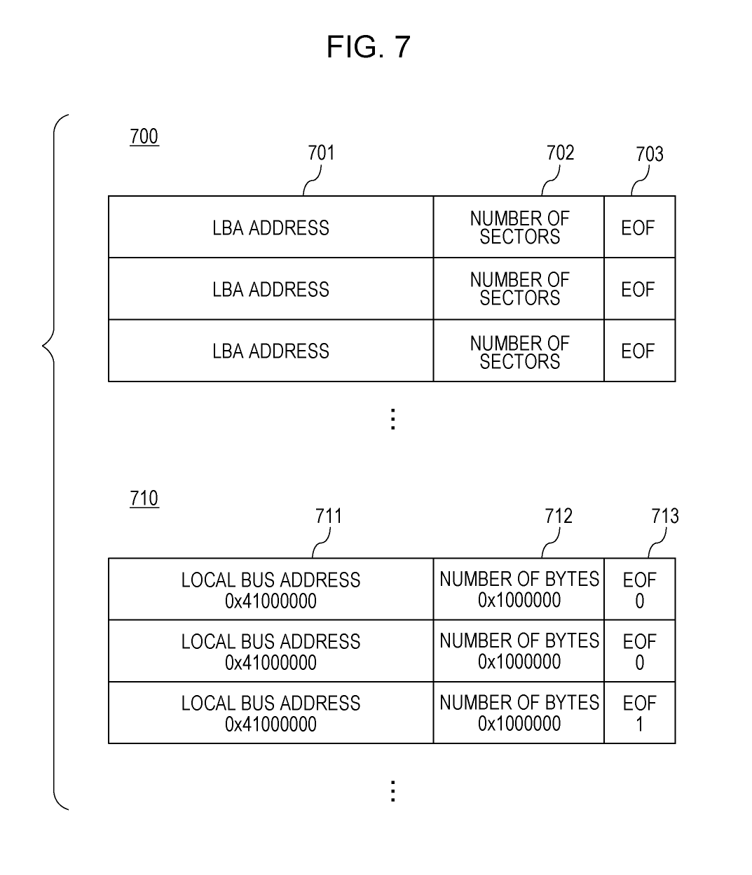

First, in the process flowchart 600, operation setting of the SATA DMAC 145 is performed by the CPU 121 in the PCIe RC 120, etc. (601). The operation setting is performed by designating an initial address of later-described two descriptor tables in FIG. 7, for example.

In FIG. 7, a table 700 is a descriptor table showing the order of reading from the HDD 163. The entries of the table 700 include a LBA address 701 representing a sector address of the HDD 163, a number of sectors 702 representing a data volume to be read from the LBA address 701, and an EOF 703 representing completion of the table. The table 710 is a descriptor table showing the order of writing to the local bus 151.

The entries of the table 710 include a local bus address 711, a number of bytes 712 representing a data volume to be written to the local bus address 711, and an EOF 713 representing completion of the table.

The SATA DMAC 145 may alternatively be set so that reading is performed from the local bus 151 side and writing is performed to the HDD 163 using the same table. In the present embodiment, data to be written needs to be written to the buffer area (write) 205 of the FIFO control unit 149 illustrated in FIG. 3. Therefore, if an initial address of this area is 0x41000000 and the size is 0x1000000, for example, setting as shown in table 710 is made.

Therefore, a write access from the SATA DMAC 145 is performed to the FIFO control unit 149. When setting is completed, start of a DMAC operation is instructed (602). Then, the SATA DMAC 145 performs reading of data from the HDD 163 in accordance with the table 700 (603).

The SATA DMAC 145 issues a write request to a slave (the FIFO control unit 149) of the area represented by the local bus address 711 of the table 710 (604). Then the SATA DMAC 145 waits for a Ready signal from the FIFO control unit 149 (605) and, when a Ready signal is returned (605: Yes), transmits write data to the FIFE) control unit 149 (606).

The SATA DMAC 145 increments the LBA address of the reading source and the address of the local bus address of the write destination and, if necessary, proceeds the entry of the descriptor table by one (607). The SATA DMAC 145 continues the processes of 603 to 607 until all the data shown in the descriptor table is transferred (608) and completes transfer.

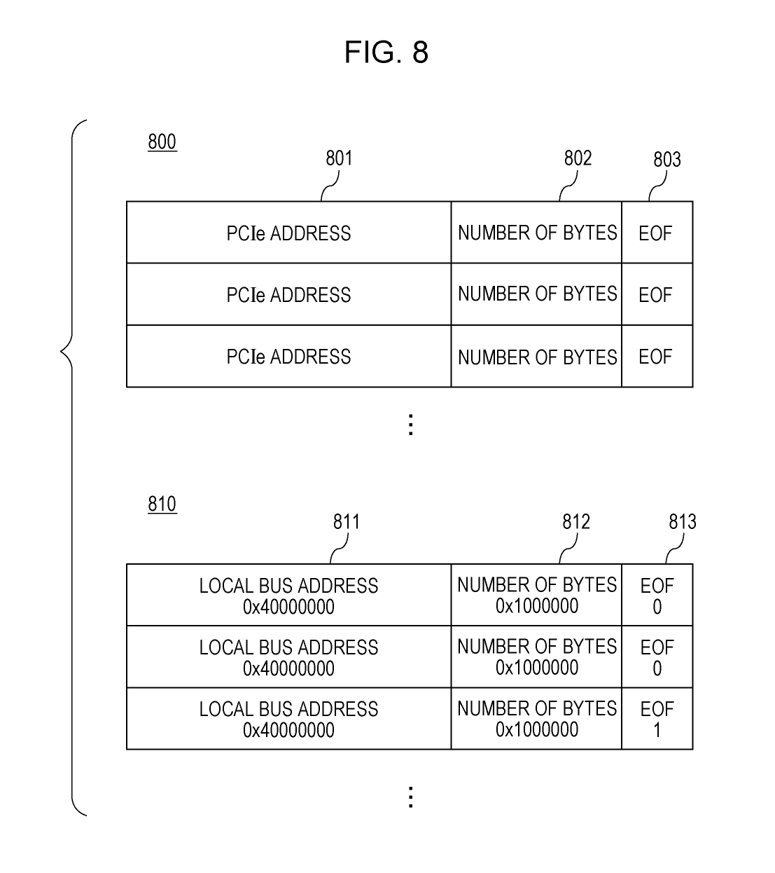

In the process flowchart 620, operation setting of the PCIe DMAC 142 is performed by the CPU 121 in the PCIe RC 120, etc. (621). The operation setting is performed by designating the initial address of two descriptor tables illustrated, for example, in FIG. 8.

In FIG. 8, a table 800 is a descriptor table showing the order of writing of data to be transferred to the PCIe RC 120 via the PCIe 167. The entries of the table 800 include a PCIe address 801 of the PCIe 167, a number of bytes 802 representing a data volume to be written to the PCIe address 801, and an EOF 803 representing completion of the table.

The table 810 is a descriptor table showing the order of reading from the local bus 151. The entries of the table 810 include a local bus address 811, a number of bytes 812 representing a data volume to be read from the local bus address 811, and an EOF 813 representing completion of the table.

The PCIe DMAC 142 may alternatively be set so that reading is performed from the space of the PCIe 167 and writing is performed to the space of the local bus 151 using the same table.

In the present embodiment, data to be read needs to be read from the buffer area (read) 206 of the FIFO control unit 149 illustrated in FIG. 3. Therefore, if an initial address of this area is 0x40000000 and the size is 0x1000000, for example, setting as shown in table 810 is made.

Therefore, a read access from the PCIe DMAC 142 is performed to the FIFO control unit 149. When setting is completed, start of a DMAC operation is instructed (622).

Then the PCIe DMAC 142 issues a read request, in order to perform reading of data from the FIFO control unit 149 in accordance with the table 810 (623). The PCIe DMAC 142 waits for a Ready signal from the FIFO control unit 149 (624) and, when a Ready signal is returned (624: Yes), receives read data from the FIFO control unit 149 (625). The received data is transmitted to the PCIe RC 120 via the PCIe 167 in accordance with the table 800 (626).

The PCIe DMAC 142 increments the local bus address of the reading source and the address of the PCIe address of the write destination and, if necessary, proceeds the entry of the descriptor table by one (627). The PCIe DMAC 142 continues the processes of 623 to 627 until all the data shown in the descriptor table is transferred (628) and completes transfer.

In the process flowchart 640, the FIFO control unit 149 has a state machine, and operates in response to write/read requests or transmission and reception of data from the SATA DMAC 145 and the PCIe DMAC 142.

First, if a write request is issued by the SATA DMAC 145, the FIFO control unit 149 checks whether the buffer 150 has available capacity (641). Available capacity of the buffer 150 is calculated from a write pointer and a read pointer which the FIFO control unit 149 has, and a volume of the buffer 150. If the FIFO control unit 149 determines that the buffer 150 has available capacity, a Ready signal is generated with respect to the write request issued by the SATA DMAC 145 (642). Then the FIFO control unit 149 receives transmitted write data and stores the received data in the buffer 150, and increments the write pointer (643).

When a read request is issued to the FIFO control unit 149 by the PCIe DMAC 142, the FIFO control unit 149 checks whether read data to be transferred to the buffer 150 exists (644). This check is performed by calculating a data volume stored in the buffer 150 from the write pointer and the read pointer which the FIFO control unit 149 has. If the FIFO control unit 149 determines that a necessary read data volume exists, a Ready signal is returned to the PCIe DMAC 142 (645).

The FIFO control unit 149 transmits the data stored in the buffer 150 to the PCIe DMAC 142 and increments the read pointer (646). Here, the FIFO control unit 149 can determine whether a necessary data volume exists in the buffer 150 as in the process 644. Therefore, the data transfer processing between the SATA DMAC 145 and the PCIe DMAC 142 can be performed in cooperation not via software control.

With the configuration described above, the SATA DMAC 145 and the PCIe DMAC 142 operate in cooperation. Therefore, data stored in an arbitrary area in the HDD can be transferred to the entire arbitrary areas in the PCIe RC 120 without increasing the load of the software process.

### Second Embodiment

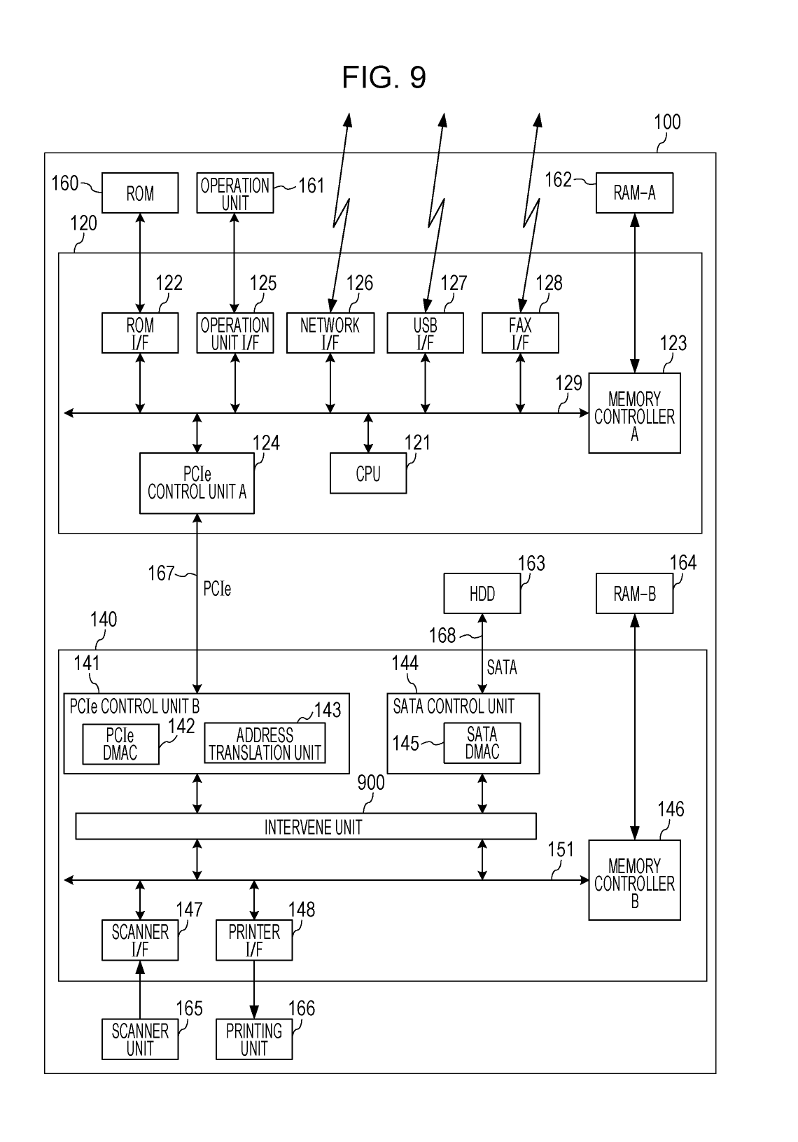

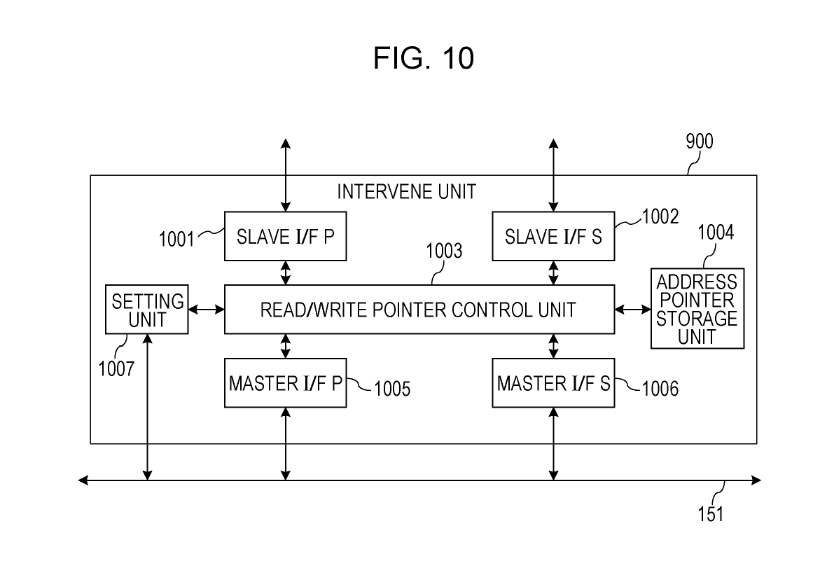

FIG. 9 is a block diagram illustrating a configuration of an information processing apparatus according to the present embodiment. Hereinafter, a configuration different from that of the first embodiment will be described. A PCIe EP 140 in the present embodiment includes an intervene unit 900 (illustrated in detail in FIG. 10) which intervenes bus accesses between a PCIe control unit B 141 and a SATA control unit 144 and a local bus 151 instead of the FIFO control unit 149.

FIG. 10 is a detailed block diagram of a configuration of the intervene unit 900 illustrated in FIG. 9.

In FIG. 10, a slave I/F P 1001 is an I/F for receiving read/write accesses from a PCIe DMAC 142 which is as a master to the local bus 151 on the way. A slave I/F S 1002 is an I/F for receiving read/write accesses from a SATA DMAC 145 which is a master to the local bus 151 on the way. A read/write pointer control unit 1003 determines whether accesses from the slave I/F P 1001 and the slave I/F S 1002 are to be allowed based on information about a setting unit 1007 and an address pointer storage unit 1004.

Regarding the setting unit 1007, setting is performed as to which area in the RAM-B 164 which is the local memory is used as FIFO.

For example, an area of the RAM-B 164 treated as FIFO is set to be 0x10000000-0x10008000 in the setting unit 1007. Then, if an access address from each of the slave I/Fs exists in the area, later-described read/write access control is performed in the read/write pointer control unit 1003. If no access address exists in the area, the access from each slave I/F is not controlled in the read/write pointer control unit 1003, and a request leaves from a master I/F P 1005 and a master I/F S 1006 toward the local bus 151. In the address pointer storage unit 1004, pointer information indicating to which address an access has been performed when a write/read access to the address area set in the setting unit 1007 is performed is stored.

If there is an access to the address area set in the setting unit 1007, the read/write pointer control unit 1003 determines whether to issue the access to the local bus 151 based on the pointer information. If the access is issued, the read/write pointer control unit 1003 updates write/read pointer information in the address pointer storage unit 1004 then.

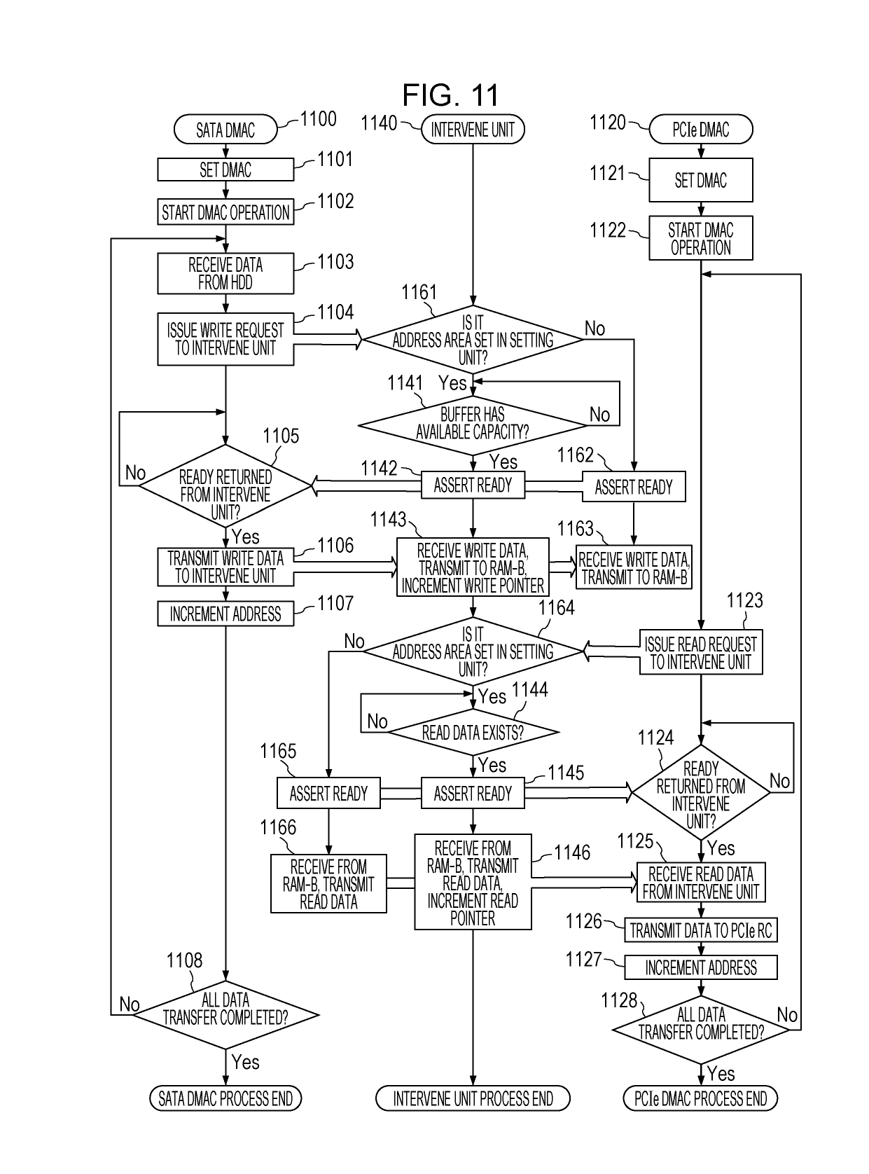

FIG. 11 is a flowchart illustrating a method for controlling the data transfer device according to the present embodiment. Hereinafter, details of access control using the intervene unit 900 will be described. Since the flowchart of this process is basically the same as that of FIG. 6, only differences therebetween will be described.

First, regarding a SATA DMAC process flowchart 1100, the flowchart differs only in that an issuance destination of a write request accesses from the FIFO control unit 149 to the RAM-B 164 via the intervene unit 900. Therefore, in the SATA DMAC process flowchart 1100, a difference is that a destination of the write access in processes 1104 to 1106 is the intervene unit 900. Therefore, in the flowchart 1120, a difference is that a destination of the read access in processes 1123 to 1125 is the intervene unit 900.

Next, an intervene unit process flowchart 1140 will be described.

When the intervene unit 900 receives a write request including a transmission destination address from the SATA DMAC 145 via the slave I/F S 1002, the intervene unit 900 determines whether the request is an access to the address area set in the setting unit 1007 (1161).

For example, as described above, an area of the RAM-B 164 treated as FIFO is set to be 0x10000000-0x10008000 in the setting unit 1007. Then, if the read/write pointer control unit 1003 determines that the access address from the slave I/F S 1002 is outside this area (1161: No), the process proceeds to (1162). The read/write pointer control unit 1003 asserts the Ready signal to the SATA DMAC 145 (1162). The read/write pointer control unit 1003 receives write data from the SATA DMAC 145 and transmits the data to the RAM-B 164 via the master I/F S 1006 (1163).

If the read/write pointer control unit 1003 determines that the access address from the slave I/F S 1002 is within the area set in the setting unit 1007 (1161: Yes), the process proceeds to (1141). The read/write pointer control unit 1003 reads pointer information from the address pointer storage unit 1004 and calculates whether the buffer 150 has available capacity (1141). If the buffer has available capacity (1141: Yes), Ready is asserted to the SATA DMAC 145 (1142). The read/write pointer control unit 1003 receives write data from the SATA DMAC 145 and transmits the data to the RAM-B 164. Finally, the read/write pointer control unit 1003 increments the write pointer of the address pointer storage unit 1004 and completes the process.

The intervene unit 900 receives a read request including a transmission destination address from the PCIe DMAC 142 via the slave I/F P 1001. Then, the read/write pointer control unit 1003 determines whether the request is an access to an address area set in the setting unit (1164). If the read/write pointer control unit 1003 determines that the access address from the slave I/F P 1001 is outside this area (1164: No), the process proceeds to (1165).

The read/write pointer control unit 1003 asserts the Ready signal to the PCIe DMAC 142 (1165). The read/write pointer control unit 1003 receives read data from the RAM-B 164 via the master I/F P 1005 and transmits the read data to the PCIe DMAC 142 (1166).

If the read/write pointer control unit 1003 determines that the access address from the slave I/F P 1001 is within the area set in the setting unit 1007 (1164: Yes), the process proceeds to (1144). The read/write pointer control unit 1003 reads pointer information from the address pointer storage unit 1004 and calculates whether read data previously written in the RAM-B 164 exists (1144). If the read/write pointer control unit 1003 determines that read data exists (1144: Yes), the Ready signal is asserted to the PCIe DMAC 142 (1145). The read/write pointer control unit 1003 receives read data from the RAM-B 164 and transmits the data to the PCIe DMAC 142. Finally, the read/write pointer control unit 1003 increments the read pointer of the address pointer storage unit 1004 and completes the process (1146).

With the configuration described above, as described in the first embodiment, provision of an additional buffer 150 or buffer areas 205 and 206 dedicated for a FIFO area is unnecessary. Therefore, the PCIe DMAC 142 and the SATA DMAC 145 can be operated cooperatively, and an initial object can be attained.

Although a case where an information processing apparatus is an image processing apparatus is described in each embodiment, the information processing apparatus may be implemented as a data transfer device it is capable of performing data transfer control described in each flowchart. Therefore, the same effect is expectable by applying an embodiment to data transfer control using different bus forms provided in various information processing apparatuses other than the image processing apparatus.

### Other Embodiments

Embodiment (s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to embodiments, it is to be understood that the invention is not limited to the disclosed embodiments. The scope of the following claims is to be accorded the broadest interpretation to encompass all such modifications and equivalent structures and functions.

This application claims the benefit of Japanese Patent Application No. 2016-038733 filed Mar. 1, 2016, which is hereby incorporated by reference herein in its entirety.

What is claimed is:

1. A data processing apparatus, comprising:
a first memory control unit configured to perform data transfer via an interface of a first bus form; and
a second memory control unit configured to perform data transfer between a memory device connected via an interface of a second bus form,
wherein the first memory control unit and the second memory control unit are connected by a local bus, and a memory control unit is provided in the local bus to control, via a predetermined buffer, a write access or a read access to the first memory control unit from the second memory control unit and control, via the predetermined buffer, a read access or a write access to the second memory control unit from the first memory control unit.

2. The data processing apparatus according to claim 1, wherein the predetermined buffer is a buffer of a first in, first out (FIFO) form.

3. The data processing apparatus according to claim 1, wherein the first memory control unit includes an address translation unit configured to translate predetermined address information into an address space managed by a device connected to the interface of the first bus form.

4. The data processing apparatus according to claim 1, wherein the interface of the first bus form is a Peripheral Component Interconnect (PCI) Express (PCIe) interface.

5. The data processing apparatus according to claim 1, wherein the interface of the second bus form is a Serial AT Attachment (SATA) interface.

6. An image processing device comprising:
the data processing apparatus according to claim 1; and
a predetermined interface connected to the first memory control unit and the second memory control unit through the local bus.

7. The image processing device according to claim 6, further comprising:
a printer; and
a scanner.

8. A method to control a data processing apparatus having a first memory control unit configured to perform data transfer via an interface of a first bus for and a second memory control unit configured to perform data transfer between a memory device connected via an interface of a second bus form, wherein the first memory control unit and the second memory control unit are connected by a local bus, the method comprising:
controlling, via a memory control unit provided in the local bus and via a predetermined buffer, a write access or a read access to the first memory control unit from the second memory control unit; and
controlling, via the memory control unit and via the predetermined buffer, a read access or a write access to the second memory control unit from the first memory control unit via the predetermined buffer.

9. A non-transitory computer-readable storage medium storing a program to cause a computer to perform a method to control a data processing apparatus having a first memory control unit configured to perform data transfer via an interface of a first bus form and a second memory control unit configured to perform data transfer between a memory device connected via an interface of a second bus form, wherein the first memory control unit and the second memory control unit are connected by a local bus, the method comprising:
controlling, via a memory control unit provided in the local bus and via a predetermined buffer, a write access or a read access to the first memory control unit from the second memory control unit; and
controlling, via the memory control unit and via the predetermined buffer, a read access or a write access to the second memory control unit from the first memory control unit via a predetermined buffer.
